(19) United States
(12) Patent Application Publication
(10) Pub. No.: US 2023/0234110 A1
(43) Pub. Date: Jul. 27, 2023

(54) APPARATUS AND METHOD FOR DESCALING A VESSEL

(71) Applicant: KT-Grant, Inc., Export, PA (US)

(72) Inventors: Timothy Aretz, Ford City, PA (US); Donald Bennett, West Mifflin, PA (US)

(73) Assignee: KT-Grant, Inc., Export, PA (US)

(21) Appl. No.: 17/584,464

(22) Filed: Jan. 26, 2022

(51) Int. Cl. B08B 9/087; C04B 7/44

(52) U.S. Cl. CPC B08B 9/087; C04B 7/4492

(57) ABSTRACT

Embodiments relate to an apparatus for descaling a vessel. The apparatus includes a frame having a frame top and a frame bottom, the frame including a longitudinal axis running from the frame top to the frame bottom. The apparatus includes an outrigger stabilizing assembly attached to the frame. The outrigger stabilizing assembly has a plurality of arms configured to extend and retract radially with respect to the longitudinal axis to abut against a wall of the vessel. The apparatus includes a turret attached to the frame bottom. The apparatus includes a hammer assembly pivotally attached to the turret. The hammer assembly has an extendable and retractable boom pivotally attached to the turret. The boom has first and second ends, and there is a reciprocating hammer pivotally attached to the second end of the boom.

### FIELD OF THE INVENTION

Embodiments relate to an apparatus for descaling a vessel that provides means to quickly and conveniently insert a frame via an opening of the vessel and assemble the apparatus via attachment of modular components while the frame is within the cavity of the vessel. The assembled apparatus has an outrigger stabilizing assembly configured to prevent or limit lateral and vertical motion of the apparatus, a pivotal, rotatable, and extendable hammer assembly for automated descaling operations, and a control module to provide remote control of the apparatus from outside the vessel cavity.

### BACKGROUND OF THE INVENTION

Known systems and methods of descaling a vessel (e.g., cement calciner) are limited to manual (e.g., hand-held and hand-operated) use of tools by humans entering a vessel cavity. The vessel cavities are large (e.g., 30 feet in diameter and 100 feet in length), and thus these operations typically require scaffold assembly and disassembly. Such operations are slow, dangerous, and inefficient. Other methods of descaling involve insertion of a weighted hose (e.g., a hose having a weighted end) into the vessel. Air of other fluid is forced through the hose and allowed to expel from the hose end to cause the hose end to flail about and make contact with the scale build-up of the vessel. This operation is uncontrolled and can cause damage to the vessel.

The present invention is directed toward overcoming one or more of the above-identified problems.

### SUMMARY OF THE INVENTION

In an exemplary embodiment, an apparatus for descaling a vessel includes a frame having a frame top and a frame bottom, the frame including a longitudinal axis running from the frame top to the frame bottom. The apparatus includes an outrigger stabilizing assembly attached to the frame. The outrigger stabilizing assembly has a plurality of arms configured to extend and retract radially with respect to the longitudinal axis to abut against a wall of the vessel. The apparatus includes a turret attached to the frame bottom. The apparatus includes a hammer assembly pivotally attached to the turret. The hammer assembly has an extendable and retractable boom pivotally attached to the turret. The boom has first and second ends. The apparatus includes a reciprocating hammer pivotally attached to the second end of the boom.

In some embodiments, the outrigger stabilizing assembly is configured to prevent or limit lateral and vertical motion of the apparatus when the plurality of arms are arranged to abut against the wall of the vessel.

In some embodiments, the plurality of arms are pivotable between a deployed position extending substantially radially to the longitudinal axis and a stored position extending substantially parallel to the longitudinal axis.

In some embodiments, the plurality of arms comprises four arms equi-angularly spaced from one another about the longitudinal axis.

In some embodiments, each arm of the plurality of arms includes an inner arm and an outer arm. The inner arm extends from and retracts within the outer arm.

In some embodiments, the reciprocating hammer is a hydraulic hammer.

In some embodiments, the boom includes an inner boom and an outer boom. The inner boom extends from and retracts within the outer boom.

In some embodiments, the apparatus includes a clevis-piston pivot structure attached to the turret. The clevis-piston pivot structure is configured to facilitate pivotal motion of the hammer assembly so as to adjust an angle the boom makes with the longitudinal axis.

In some embodiments, the turret is a hydraulic, pneumatic, and/or electric driven turret. The clevis-piston pivot structure is a hydraulic, pneumatic, and/or electric driven clevis-piston pivot structure. The outrigger stabilizing assembly is a hydraulic, pneumatic, and/or electric driven outrigger stabilizing assembly.

In some embodiments, the apparatus includes a coupler attached to the frame top, the coupler operably attachable to a hoist mechanism for raising and lowering the apparatus within the vessel.

In an exemplary embodiment, a vessel descaling system includes a frame having a frame top and a frame bottom, the frame including a longitudinal axis running from the frame top to the frame bottom. The system includes an outrigger stabilizing assembly attached to the frame. The outrigger stabilizing assembly has an outrigger stabilizing servo and a plurality of arms configured to extend and retract radially with respect to the longitudinal axis to abut against a wall of the vessel. The system includes a turret attached to the frame bottom, the turret having a turret servo. The system includes a hammer assembly pivotally attached to the turret. The hammer assembly has a hammer assembly servo. The hammer assembly has an extendable and retractable boom pivotally attached to the turret, the boom having first and second ends. The hammer assembly has a reciprocating hammer pivotally attached to the second end of the boom. The system includes a control module in communication with the outrigger stabilizing servo, the turret servo, and the hammer assembly servo.

In some embodiments, each arm of the plurality of arms has an inner arm and an outer arm. The inner arm extends from and retracts within the outer arm. The boom has an inner boom and an outer boom. The inner boom extends from and retracts within the outer boom.

In some embodiments, the system includes a clevis-piston pivot structure attached to the turret. The clevis-piston pivot structure has a clevis-piston structure servo. The clevis-piston pivot structure is configured to facilitate pivotal motion of the hammer assembly so as to adjust an angle the boom makes with the longitudinal axis. The control module is in communication with the clevis-piston structure servo.

In some embodiments, the system includes a hoist mechanism. The hoist mechanism includes a hoist mechanism servo. The system also includes a coupler attached to the frame top, the coupler operably attachable to the hoist mechanism. The control module is in communication with the hoist mechanism servo.

In an exemplary embodiment, a method of descaling a vessel involves inserting a frame through an opening of a vessel, the frame having a frame top, a frame bottom, and a longitudinal axis running from the frame top to the frame bottom. The method involves attaching an outrigger stabilizing assembly to the frame while the frame is within the vessel. The method involves attaching a turret to the frame bottom while the frame is within the vessel. The method involves rotatably and pivotally attaching a hammer assembly to the turret while the frame is within the vessel. The hammer assembly includes an extendable and retractable boom configured to pivotally attach to the turret, the boom having first and second ends. The hammer assembly includes a reciprocating hammer pivotally attached to the second end the boom.

In some embodiments, the method involves stabilizing the frame via actuation of the outrigger stabilizing assembly to prevent or limit lateral and vertical motion of the frame within the vessel.

In some embodiments, the method involves rotating the hammer assembly about the longitudinal axis, pivoting the hammer assembly to adjust an angle the hammer assembly makes with the longitudinal axis, and/or extendable and retractable the boom.

In some embodiments, the method involves inserting the frame via a hoist mechanism.

In some embodiments, the method involves controlling the outrigger stabilizing assembly and the hammer assembly via a control module.

In some embodiments, the method involves controlling the outrigger stabilizing assembly, the hammer assembly, and the hoist mechanism via a control module.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, aspects, features, advantages and possible applications of the present invention will be more apparent from the following more particular description thereof, presented in conjunction with the following Figures, in which:

FIG. 1 is an exemplary cement calciner vessel showing exemplary placement of a hoist mechanism and an apparatus.

FIGS. 2-4 show cross-sections of a vessel with an exemplary apparatus placed inside.

FIGS. 5-6 show an embodiment of a fully assembled apparatus with the hammer head in different positions.

FIG. 7 shows an exemplary frame in assembly with an exemplary outrigger stabilizing assembly.

FIG. 8 shows an exemplary arm of an exemplary outrigger stabilizing assembly.

FIGS. 9-10 shows an exemplary assembled apparatus (without the hammer head).

FIGS. 11-12 show exemplary views of an embodiment of a boom of the hammer assembly.

FIG. 13 shows an exemplary control module.

FIG. 14 shows an exemplary system schematic.

FIGS. 15-17 show an exemplary process steps that can be taken to assemble an embodiment of the apparatus.

FIG. 18 shows an exemplary apparatus being assembled with straps being used to support the plurality of arms.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

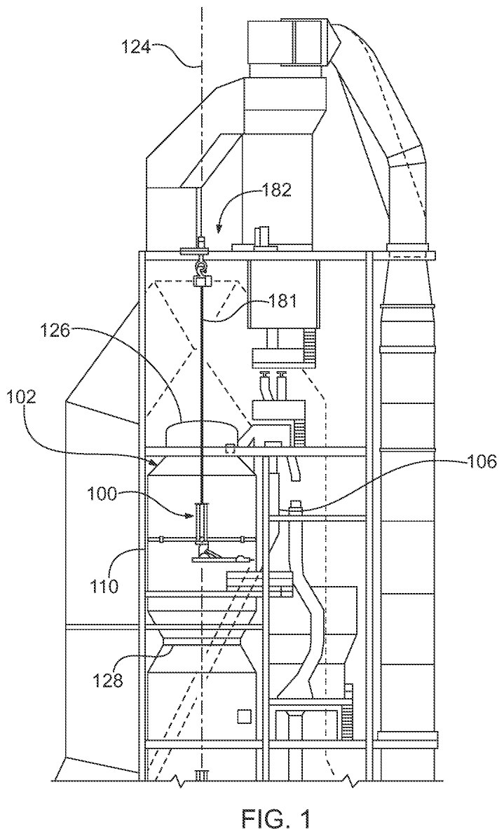

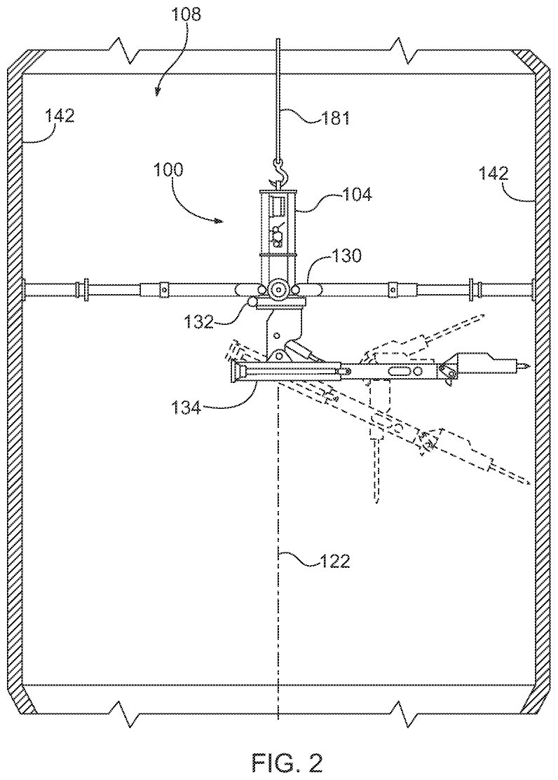

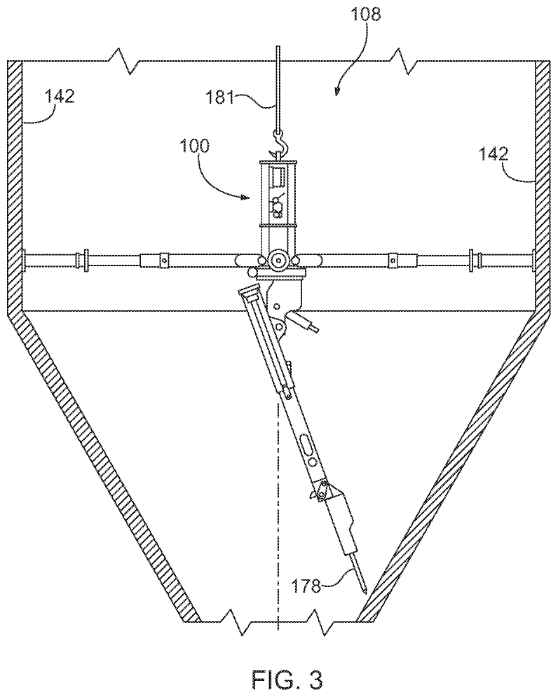

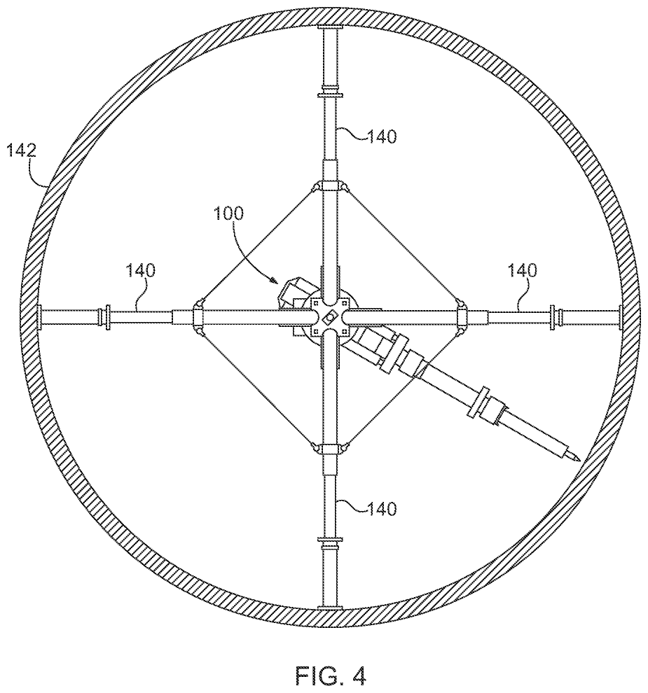

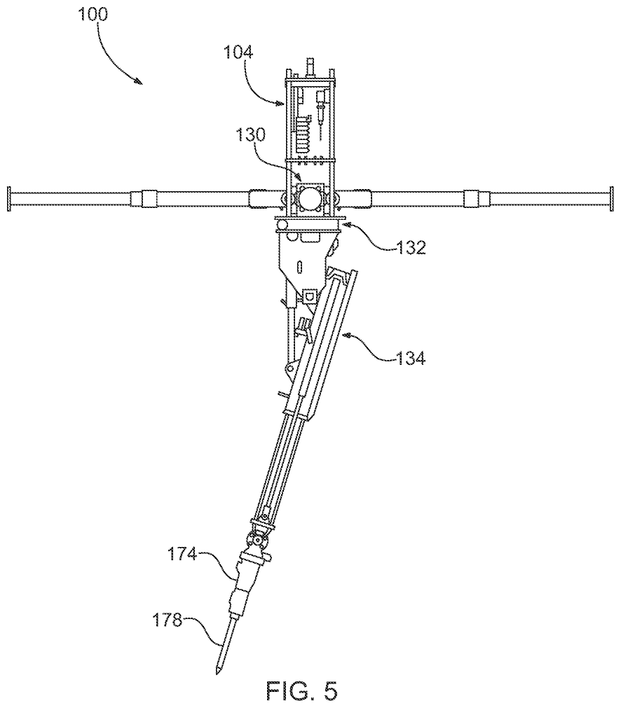

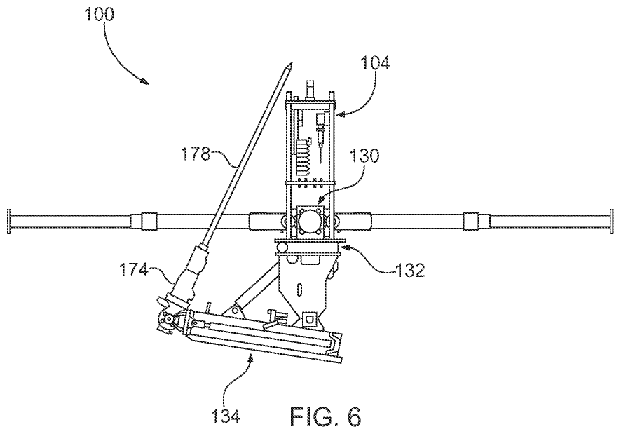

Referring to FIGS. 1-6, embodiments relate to an apparatus 100 for descaling a vessel 102 that provides means to quickly and conveniently insert a frame 104 via an opening 106 of the vessel 102 and assemble the apparatus 100 via attachment of modular components while the frame 104 is within the cavity 108 of the vessel 102. It is contemplated for the vessel 102 to be a cement calciner; however, the apparatus 100 can be used to descale other types of vessels 102. Any vessel 102 use for mass production of product (e.g., cement, steel, etc.) and develops unwanted build-up of material (e.g., scale, slag, etc.) can benefit from the disclosed apparatus 100 and method.

Cement calciner vessels 102 are typically large structures having a cylindrical shape (e.g., approximately 30 feet in diameter and 100 feet in length). The facility within which the vessel 102 is located can have a building structure built around the vessel 102 such that the vessel 102 spans several floors of the building structure. An opening 106 is typically formed in a sidewall 110 of the vessel 102, which can be at any height of the vessel 102. Some vessels 102 may have an opening at a top of the vessel 102. This opening 106 can grant access to an interior (e.g., cavity 108) of the vessel 102. With a cement calciner, the opening 106 is generally located such that a human can access the opening 106 from a floor of the building. As will be explained herein, the apparatus 100 can be inserted into the vessel cavity 108 via the opening 106. For instance, a frame 104 of the apparatus 100 can be inserted via the opening 106. While the frame 104 is within the vessel cavity 108, other modular components of the apparatus 100 can be attached to the frame 104 or to other components to build the apparatus 100. Once assembled, the apparatus 100 can be used to descale walls of the vessel cavity 108.

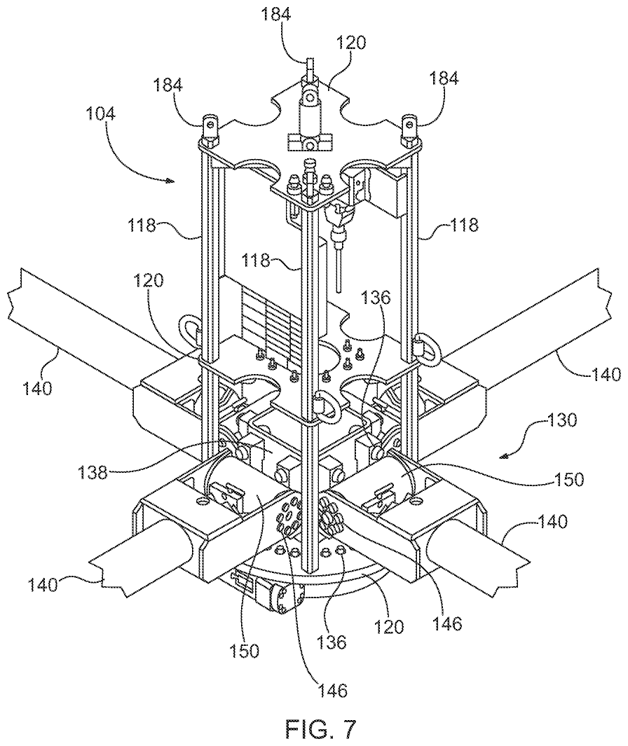

Referring to FIG. 7, the apparatus 100 includes a frame 104. The frame 104 has a frame top 112, frame bottom 114, and frame sides 116. In the exemplary embodiment shown, the frame 104 is a trestle-like structure having a cuboidal rectangular shape. The frame top 112 and frame bottom 114 form the short legs of the cuboidal rectangle and the frame sides 116 for the long legs of the cuboidal rectangle. In the exemplary embodiment shown, the frame 104 has four posts 118 arranged in a parallel manner. Each post 118 is connected to a cross-plate 120 at the frame top 112, a cross-plate 120 at the frame bottom 114 and a cross-plate 120 located at an intermediate location between the frame top 112 and frame bottom 114. The frame 104 has a longitudinal axis 122 that runs from the frame top 112 to the frame bottom 114. When the apparatus 100 is assembled, the apparatus 100 is generally orientated such that the longitudinal axis 122 is parallel with the vessel axis 124, wherein the frame top 112 is more proximate to the vessel top 126 than it is to the vessel bottom 128—i.e., the frame top 112 is facing up and the frame bottom 114 is facing down.

As will be discussed herein, the apparatus 100 is composed of modular components e.g., outrigger stabilizing assembly 130, turret 132, hammer assembly 134, etc.). Some components removably attach to the frame 104 and some components removably attach to other components. This configuration allows insertion of the frame 104 into the opening 106, after which subsequent assembly of the apparatus 100 occurs. After descaling the vessel 102, the apparatus 100 is disassembled and each component can be removed via the opening 106. Any of the frame 104 or other components can have one or more connectors 136 to facilitate such removable attachment. Some attachments may be strictly mechanical connections, but others can be electrical/hydraulic/pneumatic (depending on the driving system) along with the mechanical connection. The connector 136 can be an umbilical connector, coupling joint, quick-connect socket/coupling, pin-detent connection, collet connector, slip ring connector, magnetic connection, cotter key/pin connection, bolt/nut connection, bolt-threaded aperture connection, bayonet-style connection, etc.

The frame 104 has one or more connectors 136 at or near the frame bottom 114 to facilitate attachment of an outrigger stabilizing assembly 130.

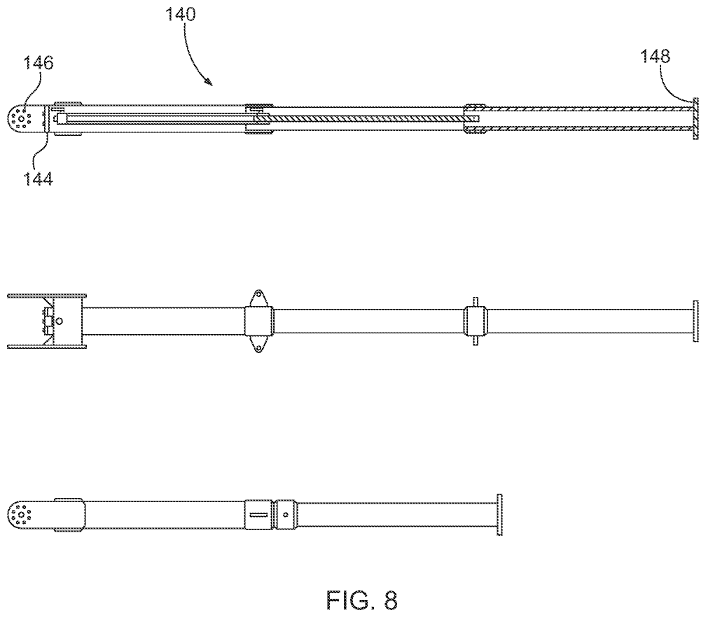

Referring to FIG. 8, the outrigger stabilizing assembly 130 is configured to prevent or limit lateral and vertical motion of the apparatus 100 when the apparatus 100 is within the vessel cavity 108. The outrigger stabilizing assembly includes a plurality of arms 140 extending from a hub 138. The hub 138 is connected to the frame 104 via at least one connector 136. Each arm 140 is configured to extend and retract radially with respect to the longitudinal axis 122. When extended, the arm 140 can abut against a wall 142 of the vessel 102. Thus, the outrigger stabilizing assembly 130 is configured to prevent or limit lateral and vertical motion of the apparatus when the plurality of arms 140 are arranged to abut against the wall 142 of the vessel 102.

Any one or combination of arms 140 are pivotable between a deployed position extending substantially radially to the longitudinal axis 122 and a stored position extending substantially parallel to the longitudinal axis 122. For instance, the arm 140 has an arm first end 144 pivotally connected to the hub 138 via an arm pivot joint 146 (a mechanical elbow joint, a universal joint, etc.) and an arm second end 148 configured to abut against the wall 142 of the vessel 102. The arm 140 can be rotated about the arm pivot joint 146 to a stored position (extending substantially parallel to the longitudinal axis 122) or to a deployed position (extending substantially radially to the longitudinal axis 122).

The plurality of arms 140 includes at least two arms 140, and the arms 140 should be located on the hub 138 so as to subtend each other. This will provide the desired stability when they are deployed and when they are abutting against the wall 142 of the vessel 102. It is contemplated for there to be four arms 140 equi-angularly spaced from one another about the longitudinal axis 122. For instance, when looking down from the frame top 112, a first arm 140 is connected to the hub 138 at a 12 o'clock position, a second arm 140 is connected to the hub 138 at a 3 o'clock position, a third arm 140 is connected to the hub at a 6 o'clock position, and a fourth arm 140 connected to the hub 138 at a 9 o'clock position. When each of the four arms 140 is deployed, each extend radially outward from the longitudinal axis 122 to generate a star-like formation. Each arm second end 148 abuts against the wall 142 of the vessel 102 such that the first arm 140 abuts the vessel wall 142 at a 12 o'clock position, the second arm 140 abuts the vessel wall 142 at a 3 o'clock position, the third arm 140 abuts the vessel wall 142 at a 6 o'clock position, and the fourth arm 140 abuts the vessel wall 142 at a 9 o'clock position.

Any one or combination of the arms 140 can be configured to extend and retract. For instance, the arm 140 can be caused to extend or retract so as to allow for adjustment of the length of the arm 140. When in the deployed position, the arm(s) 140 can be extended to ensure it/they abut(s) the wall 142 of the vessel 102, thereby preventing or limiting vertical (in a longitudinal axis direction) or lateral movement (perpendicular to a longitudinal axis direction) of the apparatus 100. When it is desired to move the apparatus 100 to a different location (e.g., move the apparatus for descaling a different area of the vessel 102, removing the apparatus 100 from the vessel 102, etc.), the arm(s) 140 can be retracted to allow for vertical and lateral movement. The extending and retracting of the arm(s) 140 can be via a telescoping arrangement. For instance, the arm 140 can have an inner arm 140 and an outer arm 140, wherein the inner arm 140 is configured to extend from and retract within the outer arm 140. This can be via a piston-cylinder arrangement, a shaft-sleeve arrangement, a threaded shaft and sleeve arrangement, a worm-gear arrangement, etc.

As will be explained herein, any one or combination of the modular components can include a servo 150. A servo 150 is a servomechanism designed to provide position an actuation control for a component. Any of the servos 150 disclosed herein can include processors, interfaces, motors, actuators, encoders, sensors, etc. to facilitate proper functioning and control.

The outrigger stabilizing assembly 130 can include one or more servos 150 to facilitate operation of this modular component. For instance, each arm 140 can have one or more servos 150 to facilitate controlled operation of arm 140 movement about the arm pivot joint 146 for storing and deploying the arms 140 and/or arm 140 extension and retraction via the telescoping arrangement.

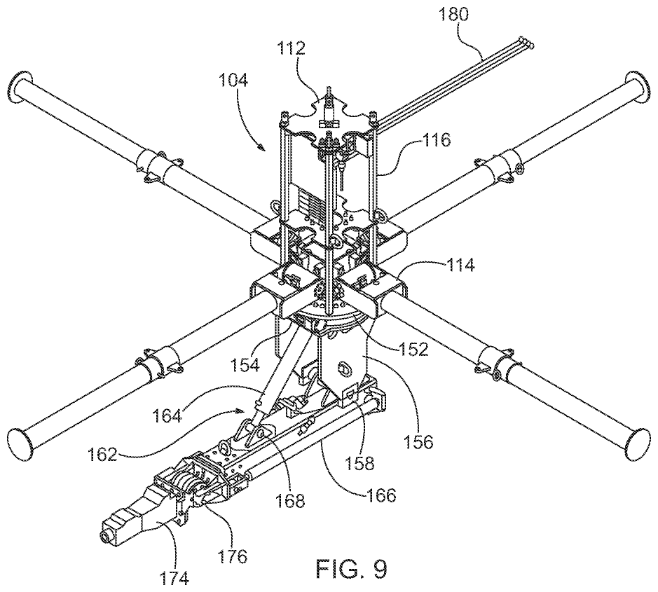

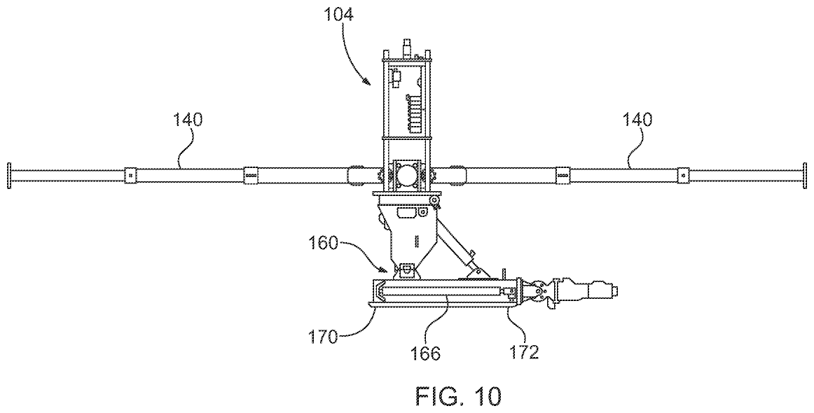

Referring to FIGS. 9-10, the apparatus 100 includes a turret 132. The turret 132 has a rotatable mount top 152 and a rotatable mount bottom 154. The turret 132, via its rotatable mount top 152, is attachable to the frame bottom 114 via at least one connector 136. The turret 132, via its rotatable mount bottom 154, is configured to allow attachment of the hammer assembly 134 thereto. The turret 132 can rotate 360° about the longitudinal axis 122 so as to allow the hammer assembly 134 (when attached) to be rotated 360° about the longitudinal axis 122—i.e., the turret 132 allows for adjustment of the hammer assembly 134 about the yaw axis of the apparatus 100. Thus, the rotatable mount is a platform having rotatable mount top 152 and a rotatable mount bottom 154, wherein the rotatable mount top 152 includes a hub and bearing or hub and race assembly, a gearing assembly, a motor, etc. to allow for free rotation of the platform. The rotatable mount bottom 154 includes at least one connector 136 to facilitate removable attachment of the hammer assembly 134. The turret 132 can include one or more servos 150 to facilitate operation of this modular component. For instance, the rotatable mount top 152 can have one or more servos 150 to facilitate controlled rotatable operation of the turret 132.

The apparatus 100 includes a hammer assembly 134. The hammer assembly 134 is attachable to the turret 132 (e.g., the rotatable mount bottom 154) via at least one connector 136. In an exemplary embodiment, the turret 132 includes a support member 156 (e.g., a truss, mast, etc.) formed on and extending from the rotatable mount bottom 154. The distal end 158 of the support member 156 includes a hammer assembly pivot joint 160 (a mechanical elbow joint, a universal joint, etc.) to facilitate pivotable attachment of the hammer assembly 134 to the support member 156 (and thus the turret 132). In the exemplary embodiment shown, the hammer assembly pivot joint 160 includes a clevis-piston pivot structure 162. The clevis-piston pivot structure 162 has a piston 164 attached to the turret 132 (e.g., to the support member 156 or the rotatable mount bottom 154) at one end of the piston 164 and to a boom 166 of the hammer assembly 134 at another end of the piston 164, each attachment being via a clevis 168. The clevis-piston pivot structure 162 facilitates controlled pivotal motion of the hammer assembly 134 via the piston 164 so as to adjust an angle the boom 166 makes with the longitudinal axis 122. For instance, actuation of the piston 164 can cause the boom 166 to pivot about the hammer assembly pivot joint 160. The hammer assembly 134 can include one or more servos 150 to facilitate operation of this modular component. For instance, a servo 150 can be associate with the piston 164 to facilitate controlled pivotal motion of the boom 166 about the hammer assembly pivot joint 160.

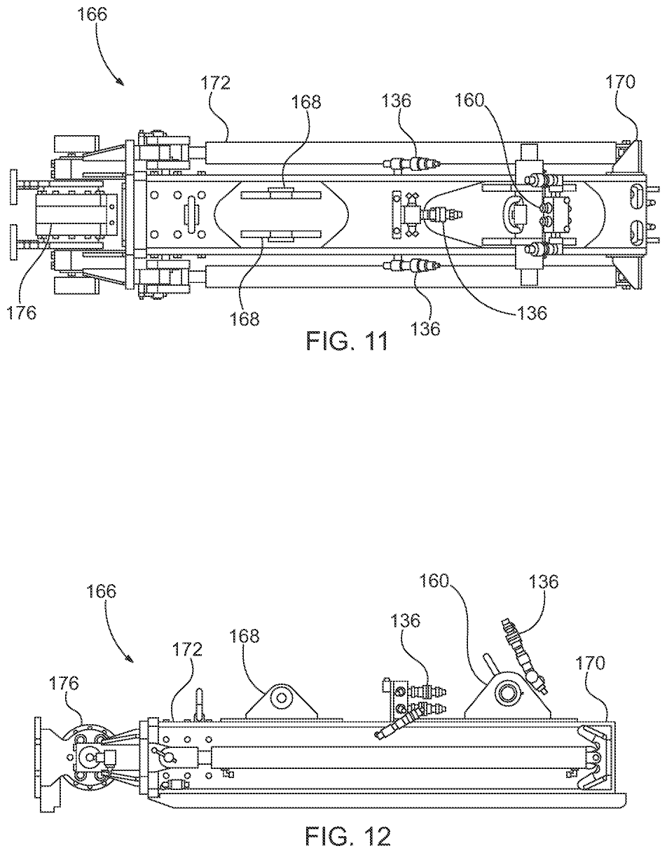

Referring to FIGS. 11-12, the hammer assembly 134 includes an extendable and retractable boom 166. The boom 166 is pivotally attached to the turret 132 via the hammer assembly pivot joint 160. As noted above, the hammer assembly pivot joint 160 is configured to allow pivotable movement of the boom 166 so as to adjust the angle the boom 166 makes with the longitudinal axis 122. The boom 166 has a boom first end 170 and a boom second end 172, a length of the boom 166 running from the boom first end 170 to the boom second end 172. The hammer assembly 134 also includes a reciprocating hammer 174 pivotally attached via a reciprocating hammer pivot joint 176 (a mechanical elbow joint, a universal joint, etc.) to the boom second end 172. The reciprocating hammer 174 includes a reciprocating motor and a chuck mechanism. The chuck mechanism facilitates removable attachment of a hammer head 178 or hammer bit. Once the apparatus 100 is assembled, the hammer assembly 134 is actuated to cause the hammer head 178 to reciprocate for descaling operations.

The boom 166 is configured to extend and retract along the length of the boom 166. The extending and retracting of the boom 166 can be via a telescoping arrangement. For instance, the boom 166 has an inner boom 166 and a boom arm 140. The inner boom 166 is configured to extend from and retract within the outer boom 166. This can be via a piston-cylinder arrangement, a shaft-sleeve arrangement, a threaded shaft and sleeve arrangement, a worm-gear arrangement, etc.

The boom 166 can be pivoted via the hammer assembly pivot joint 160, extended/retracted via the telescoping arrangement, and/or rotated via the turret 132. The reciprocating hammer 174 can be pivoted via the reciprocating hammer pivot joint 176. These movements can be done to position the hammer head 178 at a desired location on the vessel wall 142. The reciprocating hammer 174 can then be actuated to cause reciprocal motion of the hammer head 178, wherein the hammer head 178 makes repeated contact with scale built-up on the vessel wall 142 to loosen and break free the scale from the wall 142.

The hammer assembly 134 can include one or more servos 150 to facilitate operation of this modular component. For instance, the hammer assembly pivot joint 160, the clevis-piston pivot structure 162, reciprocating hammer pivot joint 176, the telescopic arrangement of the boom 166, and/or the reciprocating hammer 174, etc. can have one or more servos 150 to facilitate controlled operations of the hammer assembly 134.

It is contemplated for the reciprocating hammer 174 to be a hydraulic hammer (e.g., hydraulically driven hammer). However, the reciprocating hammer 174 can be hydraulically, pneumatically, or electrically driven. Furthermore, any of the modular components (e.g., the turret 132, the pivot joints, the clevis-piston pivot structure 162, the outrigger stabilizing assembly 130, etc.) can be configured to be hydraulically, pneumatically, and/or electrically driven. The servos 150 and connectors 136 associated therewith will also be configured accordingly. As noted herein, aspects of the modular components allow for pivotal and/or rotatable movement, as well as removable connections. To achieve these aspects, the connectors 136 can be configured as rotatable connectors, thereby facilitating electrical or fluid (hydraulic or pneumatic) connection even when the modular component is being rotated or pivoted. In addition, conduit 180 can be used to run electrical, hydraulic, or pneumatic supply lines to the servos 150 or other actuators. This conduit 180 can also run through an interior portion of the frame 104. Additional conduit 180 can be ran from the frame 104, out the opening 106, and to a (electrical, hydraulic, or pneumatic) supply.

As noted herein, the frame 104 can be inserted through the opening 106 and then, while the frame 104 is within the cavity 108 of the vessel 102, the apparatus 100 can be assembled via the modular components being attached thereto. The insertion of the frame 104 and components can be achieved via a hoist mechanism 182. The hoist mechanism 182 can be a crane, lift, winch, etc. It is contemplated for the hoist mechanism 182 to be positioned above the vessel 102 so as lower hoisting cables 181, hooks, etc. via an opening located at or near the top of the vessel 102. For instance, the hoist mechanism 182 can be an overhead crane, a winch erected on an A-frame, etc. The hoisting cables 181 of the hoist mechanism 182 can be lowered in through the top of the vessel 102 and out-through the opening 106 to allow for connecting the hoisting cables 181 to the frame 104, the frame 104 being located on a floor of the building structure. The hoist mechanism 182 can assist with maneuvering the frame 104 so as to insert it though the opening 106 and into the vessel 102 so that the frame is within the cavity 108. The hoist mechanism 182 is then used to lower the frame 104 within the vessel 102 and support the frame 104 as the apparatus 100 is assembled. During use of the apparatus 100 to descale the vessel 102, the hoist mechanism 182 can continue to be engaged with the frame 104 or detached from the frame 104 (it would only be after the outrigger stabilizing assembly 130 is attached and used to stabilize the frame 104 that disengaging the hoist mechanism 182 would occur). The hoist mechanism 182 can include at least one hook. The frame 104 can include a coupler 184 attached to the frame top 112. The coupler 184 is operably attachable to the hoist mechanism 182. For instance, the coupler 184 can be one or more a rigging units, shackles, clasps, D-rings, lifting eyes, etc. Alternatively, the hook can be engaged directly with the frame 104.

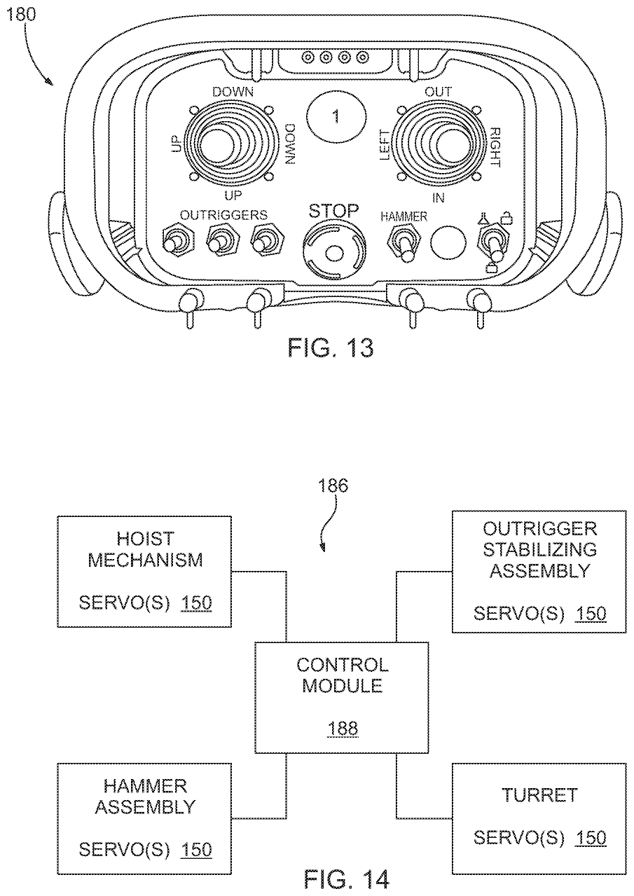

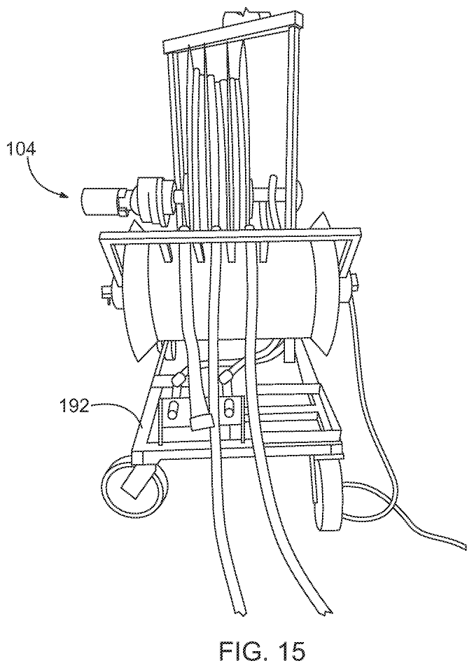

Referring to FIGS. 13-14, some embodiments relate to a vessel descaling system 186. The vessel descaling system 186 can include an embodiment of the apparatus 100 disclosed herein along with a control module 188. The control module 188 can be a processor or computer device with an interface to allow a user to exercise command and to control aspects of the apparatus 100. The control module 188 is configured to be in communication with any one or combination of the servos 150 disclosed herein. This can be via a hardwire connection (e.g., via the conduit and connectors 136) or wireless communication. For wireless communications, the control module 188 and the servos 150 can have transceivers configured to transmit and receive communication signals via a communications interface. The communications interface can include or be associated with antennas, processors, transmitters, receivers, transceivers, etc. to facilitate wireless communications. Any of the antennas discussed herein can be any device that, during transmission, receives electric current in the form of signals and radiates the energy from the electric current as electromagnetic waves. The antenna, during reception, receives electrical power of an electromagnetic wave signal (EM signal) to generate an electric current, which can be processed to derive signals therefrom. The antennas can also digitize the EM signal to generate digital data. Other components such as digitizers, switches, filters, receivers, amplifiers, etc. can be used to facilitate proper operation of the antenna.

Any of the processors discussed herein can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence program logic, machine learning program logic, automated reasoning program logic, etc. stored in memory associated with the processors. Any of the processors or computer devices can include, be part of, or be associated with a Central Processing Unit (CPU), a Graphics Processing Unit (GPUs), a Field Programmable Gate Array (FPGA), other types of processing units, etc.

Any of the memory discussed herein can be computer readable memory configured to store data. The memory can include a non-volatile, non-transitory memory (e.g., as a Random Access Memory (RAM)), and be embodied as an in-memory, an active memory, a cloud memory, etc. Embodiments of the memory can include a processor module and other circuitry to allow for the transfer of data to and from the memory, which can include to and from other components of a communication system. This transfer can be via hardwire or wireless transmission.

Any of the transceivers discussed herein can be used in combination with switches, receivers, transmitters, routers, gateways, wave-guides, etc. to facilitate communications via a communication approach that facilitates controlled and coordinated signal transmission and processing to any other component or combination of components of the system. The transmission can be via a communication link. The communication link can be electronic-based, optical-based, opto-electronic-based, quantum-based, etc.

In addition, any of the components, and in particular the servos 150, can have an application programming interface (API) and/or other interfaces configured to facilitate a computer (e.g., the control module 188 or other computer) in communication with the system 186 executing commands and controlling aspects of any one or combination of components. For example, an embodiment of the control module 188 can include, be part of, or be associated with a computer (e.g., a server, a mainframe computer, a desk top computer, a laptop computer, a tablet, a smartphone, etc.) configured to be in communication with any one or combination of components of the system 186. The computer can be programmed to generate a user interface configured to facilitate control of and display of various operational aspects of the system 186, including operational aspects of any component of the system 186.

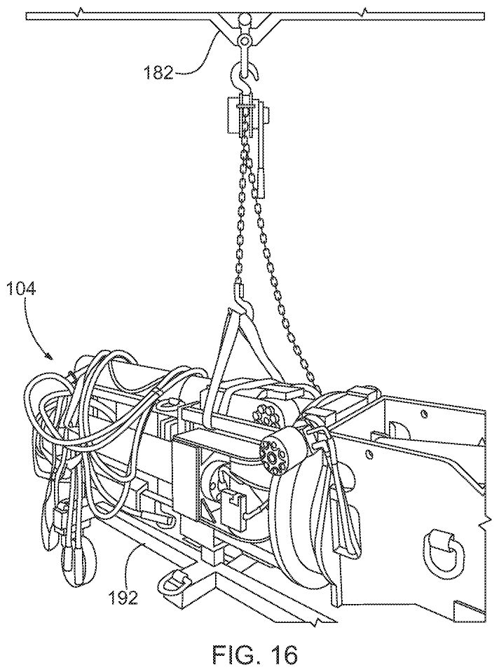

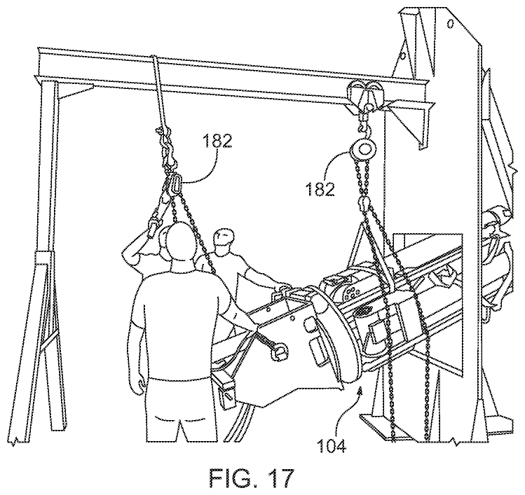

Referring to FIGS. 15-18, an exemplary method of using the apparatus 100 can be as follows. The frame 104 can be transported to the opening 106 of the vessel 102. For instance, the frame 104 can be placed on a wheeled cart 192 and transported to a floor of the building where the opening 106 is located. A hoist mechanism 182 can be used to lift the frame 104 and maneuver it so as to insert it into the opening 102 so that the frame 104 is at least partially within the cavity 108 of the vessel 102 (e.g., the frame 104 can rest on the sidewall 110 of the vessel 102). For instance, a user can attached the hoist mechanism 182 to the frame via the coupler 184. The frame 104 can be inserted through the opening 106 with the hoist mechanism 182 attached thereto, wherein a user controls the hoist mechanism 182 to controllably insert the frame 104 within the vessel 102. Control of the hoist mechanism 182 can be via the control module 188. As the frame 104 is at least partially within the vessel 102, the assembly of the apparatus 100 can occur. At this stage, it is contemplated for the turret 132 to already be attached to the frame bottom 114 before the frame 104 is transported to the opening 106. In some embodiments, the hub 138 of the outrigger stabilizing assembly 130 can also already be attached to the frame 104. However, the turret 132 and/or the hub 138 can be attached while the frame 104 is partially within the vessel 102. For instance, another hoist mechanism 182 can be used to lift the turret 132 and/or hub 138 and hold them in place while each component is secured to the frame 104 via the connectors 136. Resting the frame 104 on the sidewall 110 and/or supporting it via the hoist mechanism 182 allows for convenient assembly of the frame 104. It should be noted that other jig-like devices can be used to assist with supporting components, proper alignment of components, and precise placement of components during assembly. As the apparatus 100 is being assembled, the frame 104 can be maneuvered in and out from the opening 106 as needed.

While the frame 104 is within (at least partially within) the vessel 102, the outrigger stabilizing assembly 130, or at least portions thereof, can be attached to the frame 104. For instance, the hub 138 can be connected to the frame bottom 114 via the connectors 136, unless it is already connected thereto. Once the hub 138 is connected, each arm 140 of the plurality of arms 140 can be can be connected to the hub 138 via the arm pivot joint 146 of its arm first end 144. For instance, a first arm 140 can be connected to the hub 138. This can involve attaching the outer arm segment to the hub 138, attaching the inner arm segment to the outer arm segment, maneuvering the frame 104 inward so that the entire frame 104 enters the cavity 108, rotating the frame 104 and moving it closer to the opening 106 so as to allow for attachment of a second arm 140 in a similar manner. In the exemplary embodiment, four arms 140 are connected to the hub 138 so as to be equi-angularly spaced from one another about the longitudinal axis 122. Thus, the above process can be performed for each of the four arms 140. In the alternative, the outrigger stabilizing assembly 130 can already be connected to the frame 104, wherein the frame 104 and outrigger stabilizing assembly 130 are inserted through the window 106 while the arms 140 of the outrigger stabilizing assembly 130 are in a stored position. Once inserted and the arms 140 are connected (unless they are already connected), the arms 140 are pivoted to a deployed position. Control of the arms 140 in this manner can be via the control module 188.

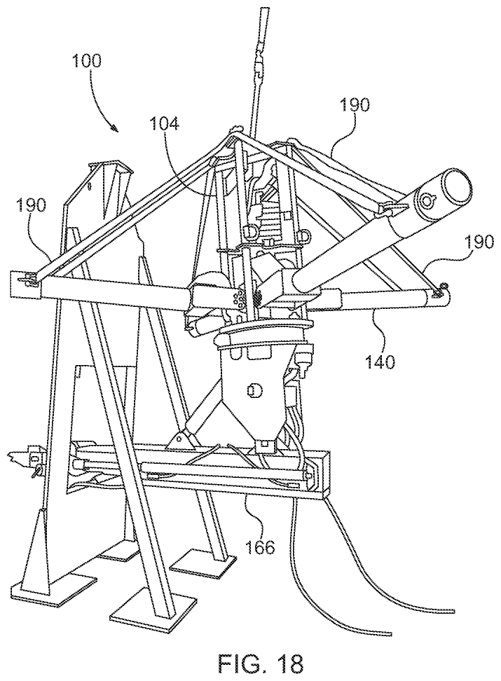

In some embodiments, straps 190 (e.g., nylon) can be used to tether the plurality of arms 140 when in a deployed position so as to stabilize the arms 140 during assembly or movement of the apparatus 100. (See FIG. 18). Each strap 190 can be connected to the frame top 112 and tethered to a portion of an arm 140. When transitioning from the deployed position to the stored positon, the straps 190 can fold upon themselves and rest on the frame 104.

Similar maneuvering and positioning of the frame 104 and any attached components can be done to attach the hammer assembly 134 (or any portion of the hammer assembly 134).

After assembly, the arms 140, if not already done so, can be transitioned to a deployed position. Once in the deployed positon, any one or combination of the arm(s) 140 can be extended or retracted to so as to adjust the length of the arm(s) 140. For instance, the apparatus 100 can be lowered within the vessel 102 to a desired height within the vessel 102 but may not be centered in the vessel 102. Extending the arm(s) 140 can allow a user to center the apparatus 100 within the cavity 108 or position the apparatus 100 at any desired lateral position within the vessel 102—this may require one or more of the arm(s) 140 to be extended more so than another arm 140. Once the desired vertical and lateral position of the apparatus 100 is attained, the plurality of arms 140 can be extended out so that each abuts against the wall 142 of the vessel to prevent or limit vertical and lateral motion of the apparatus 100. It is also understood that the vertical and lateral position can be held steady (e.g., extend the arms 140) at a more conducive location for additional assembly of the apparatus 100 and then the assemblage of the apparatus 100 can be subsequently moved (e.g., retract the arms 140) to a desired location (e.g., extend the arms 140 again) for descaling operations. Control of the arms 140 in this manner can be via the control module 188.

After the apparatus 100 is fully assembled, the apparatus 100 can be moved to a desired location for descaling operations. This can involve retracting the arms 140 to allow for vertical and lateral displacement of the apparatus 100. The apparatus 100 can then be raised or lowered via the hoist mechanism 182. Once a desired location for performing descaling operations is attained, the arms 140 can be extended to stabilize (prevent or limit vertical and lateral motion) the apparatus 100. The hammer assembly 134 can be rotated via the turret 132, the boom 166 can be pivoted, the boom 166 can be extended/retracted, and/or the reciprocating hammer 174 can be pivoted to move the hammer head 178 to a desired location. For instance, the aspects of the hammer assembly 134 can be actuated to cause the tip of the hammer head 178 to be positioned at a desired place on the vessel wall 142 for descaling. The reciprocating hammer 174 can then be actuated to cause the hammer head 178 to reciprocate, thereby making repeated contact with scale built-up on the vessel wall 142 to loosen and break free the scale from the wall 142.

After a portion of the wall 142 is adequately descaled, the hammer assembly 134 can be actuated to move the hammer head 178 to a different location. After all the portions that are reachable by the hammer head 178 have been descaled, the arms 140 can be retracted to allow for vertical and lateral movement of the apparatus 100. The apparatus 100 can then be moved to a different location within the vessel 102. The arms 140 can be extended to stabilize the apparatus 100 and allow for descaling operations at the new location.

After a desired amount of descaling is performed, the apparatus 100 can be disassembled and removed, component by component, via the opening 106.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

1. An apparatus for descaling a vessel, the apparatus comprising:
a frame having a frame top and a frame bottom, the frame including a longitudinal axis running from the frame top to the frame bottom;
an outrigger stabilizing assembly attached to the frame, the outrigger stabilizing assembly comprising a plurality of arms configured to extend and retract radially with respect to the longitudinal axis to abut against a wall of the vessel, the outrigger stabilizing assembly including:
an individual first servo for each individual arm to facilaite extension and retraction of an arm independently of extension and retraction of other arms; and
an individual second servo for each individual arm to facilitate pivotable motion of an arm about a pivot joint independently of pivotable motion of other arms about its pivot joint;
a turret attached to the frame bottom;
a hammer assembly pivotally attached to the turret, the hammer assembly comprising:
an extendable and retractable boom pivotally attached to the turret, the boom having first and second ends; and
a reciprocating hammer pivotally attached via a hammer assembly servo to the second end of the boom, the servo providing 180 degrees of movement for the reciprocating hammer.

2. The apparatus of claim 1, wherein the outrigger stabilizing assembly is configured to prevent or limit lateral and vertical motion of the apparatus when the plurality of arms is arranged to abut against the wall of the vessel.

3. The apparatus of claim 1, wherein the plurality of arms is pivotable between a deployed position extending substantially radially to the longitudinal axis and a stored position extending substantially parallel to the longitudinal axis.

4. The apparatus of claim 1, wherein the plurality of arms comprises four arms equi-angularly spaced from one another about the longitudinal axis.

5. The apparatus of claim 1, wherein each arm of the plurality of arms comprises an inner arm and an outer arm, and the inner arm extends from and retracts within the outer arm.

6. The apparatus of claim 1, wherein the reciprocating hammer comprises a hydraulic hammer.

7. The apparatus of claim 1, wherein the boom comprises an inner boom and an outer boom, and the inner boom extends from and retracts within the outer boom.

8. The apparatus of claim 1, further comprising:
a clevis-piston pivot structure attached to the turret, the clevis-piston pivot structure configured to facilitate pivotal motion of the hammer assembly so as to adjust an angle the boom makes with the longitudinal axis.

9. The apparatus of claim 8, wherein:
the turret is a hydraulic, pneumatic, and/or electric driven turret;
the clevis-piston pivot structure is a hydraulic, pneumatic, and/or electric driven clevis-piston pivot structure; and
the outrigger stabilizing assembly is a hydraulic, pneumatic, and/or electric driven outrigger stabilizing assembly.

10. The apparatus of claim 1, further comprising a coupler attached to the frame top, the coupler operably attachable to a hoist mechanism for raising and lowering the apparatus within the vessel.

11. A vessel descaling system, comprising:
a frame having a frame top and a frame bottom, the frame including a longitudinal axis running from the frame top to the frame bottom;
an outrigger stabilizing assembly attached to the frame, the outrigger stabilizing assembly comprising an outrigger stabilizing servo and a plurality of arms configured to extend and retract radially with respect to the longitudinal axis to abut against a wall of the vessel, the outrigger stabilizing assembly including:
an individual first servo for each individual arm to facilaite extension and retraction of an arm independently of extension and retraction of other arms; and
an individual second servo for each individual arm to facilitate pivotable motion of an arm about a pivot joint independently of pivotable motion of other arms about its pivot joint;
a turret attached to the frame bottom, the turret comprising a turret servo;
a hammer assembly pivotally attached to the turret, the hammer assembly comprising:
a hammer assembly servo;
an extendable and retractable boom pivotally attached to the turret, the boom having first and second ends; and
a reciprocating hammer pivotally attached via a servo to the second end of the boom, the servo providing 180 degrees of movement for the reciprocating hammer; and
a control module in communication with the outrigger stabilizing servo, the turret servo, and the hammer assembly servo.

12. The system of claim 11, wherein:
each arm of the plurality of arms comprises an inner arm and an outer arm, and the inner arm extends from and retracts within the outer arm; and
the boom comprises an inner boom and an outer boom, and the inner boom extends from and retracts within the outer boom.

13. The system of claim 11, further comprising:
a clevis-piston pivot structure attached to the turret, the clevis-piston pivot structure comprising a clevis-piston structure servo and configured to facilitate pivotal motion of the hammer assembly so as to adjust an angle the boom makes with the longitudinal axis;
wherein the control module is in communication with the clevis-piston structure servo.

14. The system of claim 11, further comprising:
a hoist mechanism, the hoist mechanism including a hoist mechanism servo; and
a coupler attached to the frame top, the coupler operably attachable to the hoist mechanism;
wherein the control module is in communication with the hoist mechanism servo.

15. A method of descaling a vessel, the method comprising:
inserting a frame through an opening of a vessel, the frame having a frame top, a frame bottom, and a longitudinal axis running from the frame top to the frame bottom;
attaching an outrigger stabilizing assembly to the frame while the frame is within the vessel;
attaching a turret to the frame bottom while the frame is within the vessel;
rotatably and pivotally attaching a hammer assembly to the turret while the frame is within the vessel, the hammer assembly comprising:
an extendable and retractable boom configured to pivotally attach to the turret, the boom having first and second ends; and
a reciprocating hammer pivotally attached to the second end the boom.

16. The method of claim 15, further comprising:
stabilizing the frame via actuation of the outrigger stabilizing assembly to prevent or limit lateral and vertical motion of the frame within the vessel.

17. The method of claim 15, further comprising:
rotating the hammer assembly about the longitudinal axis;
pivoting the hammer assembly to adjust an angle the hammer assembly makes with the longitudinal axis; and/or
extendable and retractable the boom.

18. The method of claim 15, further comprising:
inserting the frame via a hoist mechanism.

19. The method of claim 15, further comprising:
controlling the outrigger stabilizing assembly and the hammer assembly via a control module.

20. The method of claim 18, further comprising:
controlling the outrigger stabilizing assembly, the hammer assembly, and the hoist mechanism via a control module.
